(19) United States
(12) Patent Application Publication
(10) Pub. No.: US 2017/0039628 A1
(43) Pub. Date: Feb. 9, 2017

(54) IMAGE PROCESSING METHOD AND APPARATUS

(71) Applicant: ALIBABA GROUP HOLDING LIMITED, George Town (KY)

(72) Inventors: Xin WANG, Hangzhou (CN); Lan LIN, Hangzhou (CN); Fang GAO, Hangzhou (CN); Ying WANG, Hangzhou (CN); Jing LIU, Hangzhou (CN)

(21) Appl. No.: 15/229,851

(22) Filed: Aug. 5, 2016

(30) Foreign Application Priority Data
Aug. 6, 2015 (CN) 201510478166.9

(51) Int. Cl. G06Q 30/06

(52) U.S. Cl. CPC G06Q 30/0643; G06Q 30/0621; G06F 3/04842

(57) ABSTRACT

An image processing method. The method includes receiving, at a client terminal, a user request for displaying one or more outfit designs; identifying at least one matching condition associated with the outfit designs; sending a request for image information to a server, wherein the request includes the at least one matching condition; receiving the image information from the server, wherein the image information includes three-dimensional image information of an apparel item and one or more matching apparel items; and displaying one or more outfit images based on the three-dimensional image information and a preset template.

### CROSS-REFERENCE TO RELATED APPLICATION

This application is based upon and claims priority to Chinese Patent Application No. 201510478166.9, filed Aug. 6, 2015, the entire contents of which are incorporated herein by reference.

### TECHNICAL FIELD

The present application relates to the technical field of information processing and, more particularly, to an image processing method and an apparatus.

### BACKGROUND

E-commerce platforms provide sales for many types of goods, among which apparel is one of the major categories. The term “apparel” includes a variety of personal items, such as clothing, shoes, hats, socks, gloves, scarves, ties, bags, umbrellas, hair accessories and so on. In daily life, apparel items generally go with each other to make an outfit. The kinds of apparel items sold in the e-commerce platform are massive. For a buyer who has purchased an apparel item via the e-commerce platform, it may be difficult for the buyer to choose other apparel items that match with the purchased item without having personally seen the purchased item.

Conventionally, details and pictures of the goods may be provided in the product description page of the e-commerce platform for visual representation. For apparel items, pictures of models wearing the items are often provided to illustrate the fit and design of the items. These pictures usually target for individual items that are offered for sale. While the models may wear other apparel items matching the item being offered for sale in the pictures, the matching items generally require a manual search by the user, or may not be offered for sale in the network platform, or may not satisfy the user's taste. Thus, the conventional e-commerce platform does not meet the users' needs in finding apparel items that together make an attractive outfit and, as a result, limits the transactions completed by the network platform.

### SUMMARY

The present disclosure provides an image processing method. Consistent with some embodiments, the method includes receiving, at a client terminal, a user request for displaying one or more outfit designs; identifying at least one matching condition associated with the outfit designs; sending a request for the image information to a server, wherein the request includes the at least one matching condition; receiving image information from the server, wherein the image information includes three-dimensional image information of an apparel item and one or more matching apparel items; and displaying one or more outfit images based on the three-dimensional image information and a preset template.

Consistent with some embodiments, this disclosure provides another image processing method. The method includes establishing an outfit database storing three-dimensional images of a plurality of apparel items; receiving a request for image information from a client terminal, the request including at least one matching condition associated with the image information; identifying, based on the outfit database and the at least one matching condition, one or more outfit designs; and sending the image information to the client terminal, wherein the image information includes the one or more outfit designs and three-dimensional image information of an apparel item and one or more matching apparel items.

Consistent with some embodiments, this disclosure provides another image processing method. The method includes receiving, at a client terminal, a user request for displaying one or more outfit designs; identifying at least one matching condition associated with the outfit designs; sending a request for image information to a server, wherein the request includes the at least one matching condition; receiving one or more outfit images from a server, wherein the outfit images include an apparel item and one or more matching apparel items generated according to a template; and displaying the one or more outfit images.

Consistent with some embodiments, this disclosure provides another image processing method. The method includes establishing an outfit database storing one or more outfit designs, each of the outfit designs including an apparel item and one or more matching apparel items; receiving a request for image information from a client terminal, the request including at least one matching condition associated with the image information; identifying, based on the outfit database and the at least one matching condition, the one or more outfit designs; sending, to an image processing server, an identifier of the apparel item and identifiers of the matching apparel items; receiving, from the image processing server, one or more outfit images including the apparel item and the matching apparel items generated according to a template; and sending, to the client terminal, the outfit designs and the outfit images.

Consistent with some embodiments, this disclosure provides an image processing apparatus. The apparatus includes an identifying unit that receives a user request for displaying one or more outfit designs and identify at least one matching condition associated with the outfit designs; a sending unit that sends a request for image information to a server, wherein the request includes the at least one matching condition; a receiving unit that receives the image information from the server, wherein the image information includes three-dimensional image information of an apparel item and one or more matching apparel items; and a generating unit that generates one or more outfit images based on the three-dimensional image information and a preset template.

Consistent with some embodiments, this disclosure provides an image processing apparatus. The apparatus includes an establishing unit that establishes an outfit database storing three-dimensional images of a plurality of apparel items; a receiving unit that receives a request for image information from a client terminal, the request including at least one matching condition associated with the image information; an identifying unit that identifies, based on the outfit database and the at least one matching condition, one or more outfit designs; and a sending unit that sends the image information to the client terminal, wherein the image information includes the one or more outfit designs and three-dimensional image information of an apparel item and one or more matching apparel items.

Consistent with some embodiments, this disclosure provides another image processing apparatus. The apparatus includes an identifying unit that receives a user request for displaying one or more outfit designs and identify at least one matching condition associated with the outfit designs; a sending unit that sends a request for image information to a server, wherein the request includes the at least one matching condition; and a displaying unit that displays one or more outfit images received from the server, wherein the outfit images include an apparel item and one or more matching apparel items generated according to a template.

Consistent with some embodiments, this disclosure provides another image processing apparatus. The apparatus includes an establishing unit that establishes an outfit database storing one or more outfit designs, each of the outfit designs including an apparel item and one or more matching apparel items; a receiving unit that receives a request for image information from a client terminal, the request including at least one matching condition associated with the image information; an identifying unit that identifies, based on the outfit database and the at least one matching condition, one or more outfit designs; a sending unit that send, to an image processing server, an identifier of the apparel item and identifiers of the matching apparel items; and a providing unit that provides the image information to the client terminal, wherein the image information includes the outfit designs and one or more outfit images, the outfit images including the apparel item and the matching apparel items generated according to a template.

Consistent with some embodiments, this disclosure provides a non-transitory computer readable medium that stores a set of instructions that are executable by at least one processor of a server to cause the server to perform an image processing method. The method includes establishing an outfit database storing three-dimensional images of a plurality of apparel items; receiving a request for image information from a client terminal, the request including at least one matching condition associated with the image information; identifying, based on the outfit database and the at least one matching condition, one or more outfit designs; and sending the image information to the client terminal, wherein the image information includes the one or more outfit designs and three-dimensional image information of an apparel item and one or more matching apparel items.

Consistent with some embodiments, this disclosure provides another non-transitory computer readable medium that stores a set of instructions that are executable by at least one processor of a server to cause the server to perform an image processing method. The method includes establishing an outfit database storing one or more outfit designs, each of the outfit designs including an apparel item and one or more matching apparel items; receiving a request for image information from a client terminal, the request including at least one matching condition associated with the image information; identifying, based on the outfit database and the at least one matching condition, the one or more outfit designs; sending, to an image processing server, an identifier of the apparel item and identifiers of the matching apparel items; receiving, from the image processing server, one or more outfit images including the apparel item and the matching apparel items generated according to a template; and sending, to the client terminal, the outfit designs and the outfit images.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of an exemplary image processing method, consistent with the present disclosure.

FIGS. 2-1 to 2-6 are schematic diagrams illustrating user interfaces for providing outfit images, consistent with some embodiments of this disclosure.

FIG. 3 is a flowchart of an exemplary image processing method, consistent with some embodiments of this disclosure.

FIG. 4 is a flowchart of an exemplary image processing method, consistent with some embodiments of this disclosure.

FIG. 5 is a flowchart of an exemplary image processing method, consistent with some embodiments of this disclosure.

FIG. 6 is a block diagram of an exemplary image processing apparatus, consistent with some embodiments of this disclosure.

FIG. 7 is a block diagram of another exemplary image processing apparatus, consistent with some embodiments of this disclosure.

FIG. 8 is a block diagram of another exemplary image processing apparatus, consistent with some embodiments of this disclosure.

FIG. 9 is a block diagram of another exemplary image processing apparatus, consistent with some embodiments of this disclosure.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Consistent with some embodiments of this disclosure, an outfit database storing one or more outfit designs may be included in a server. Each outfit design may include a set of apparel items that can be worn together by a user. In addition to an apparel item selected by a user, outfit designs and images illustrating the designs may be presented to the user, thereby improving the user experience when shopping for apparel items.

Table 1 shows an example outfit database, consistent with some embodiments of this disclosure. As shown in Table 1, each apparel item corresponds to one or more matching items.

TABLE 1
An Example Outfit Database

| Apparel Item | Matching Apparel Items |
|---|---|
| Item A | Item 1, Item 2 . . . |
| Item B | Item 3, Item 4 . . . |
| Item C | Item 5, Item 6 . . . |
| . . . | . . . |

In some implementations, a matching degree may be stored in the outfit database for each pair of matching apparel items. For example, for each apparel item in the first column of Table 1, the matching apparel items listed in the second column may be provided in an order according to the corresponding matching degrees.

Table 2 shows another example outfit database, consistent with some embodiments of this disclosure. As shown in Table 2, the matching degree between each pair of matching apparel items is provided.

TABLE 2
Another Example Outfit Database

| Apparel Item | Matching Apparel Item | Matching Degree |
|---|---|---|
| Item A | Item 1 | D1 |
| Item A | Item 2 | D2 |
| Item B | Item 3 | D3 |
| . . . | . . . | . . . |

The outfit database may be generated by a developer based on personal experience, or by using data mining methods to gather and analyze data relating to apparel items. For example, data being gathered may include an apparel item's color, texture, style, a fashion element, price, and so on. Previous behavior records made by a user, such as the user's purchase history, favorite collections, browsing history, may also be gathered. As another example, design information provided by the item designer or outfit images in the Internet may also be gathered for creating outfit designs in the outfit database.

In some embodiments, a feature tag may be generated for each pair of matching apparel items. For example, the feature tag may describe one or more of the following: outfit style (formal, casual, etc.), price, suitable occasions (work, parties, outdoor activities, etc.), group of customer (e.g., different age groups), and so on. For example, the feature tag may be added by a professional according to the characteristics of each item. As another example, the feature tag may be added by a user after the outfit design is provided to the user, and the server may store the feature tag in the outfit database.

In some embodiments, a merchant identifier corresponding to each item in an outfit design may be stored in the outfit database, such that a user may filter the outfit designs based on the merchants. In some implementations, an outfit database may be established for each merchant, where each item in the outfit designs is offered by the same merchant.

In some embodiments, the category information of each matching apparel item may be stored in the outfit database, such that a user may select the matching items based on the apparel category. For example, a listing of categories may be provided to the user, and the user may select one or more categories for display of the matching apparel items.

Table 3 shows another example outfit database, consistent with some embodiments of this disclosure. As shown in Table 3, feature tags, merchant information, and category information of the items are provided in the outfit database.

TABLE 3
Another Example Outfit Database

| | | | | Merchant | Merchant | Category |
|---|---|---|---|---|---|---|
| Apparel | Matching | Matching | | (Apparel | (Matching | (Matching |
| Item | Item | Degree | Feature Tag | Item) | Item) | Item) |
| Item A | Item 1 | D1 | outdoor sports; | Shop 1 | Shop 2 | Coat |
| | | | 20-29 years old | | | |
| . . . | . . . | . . . | . . . | . . . | . . . | . . . |

Based on the outfit database, outfit designs may be provided to the user. Thereafter, user activities on the provided outfit designs may be monitored, and the matching degrees in the outfit database may be modified based on the user activities. For example, after an outfit design is provided to a user, if the user purchases a matching item or adds the outfit design to a favorites list of the user, it may be determined that the outfit design is effectively used once. As another example, a user may share one or more of the outfit designs with other users, and the activity performed by the other users with respect to the shared outfit designs may also be monitored. If a user shares an outfit design with user A, and user A adds the outfit design to his favorites list or purchases an item in the outfit design, it may be determined that the outfit design is effectively used once. Based on the user activities on the outfit designs, the matching degrees in the outfit database may be adjusted accordingly.

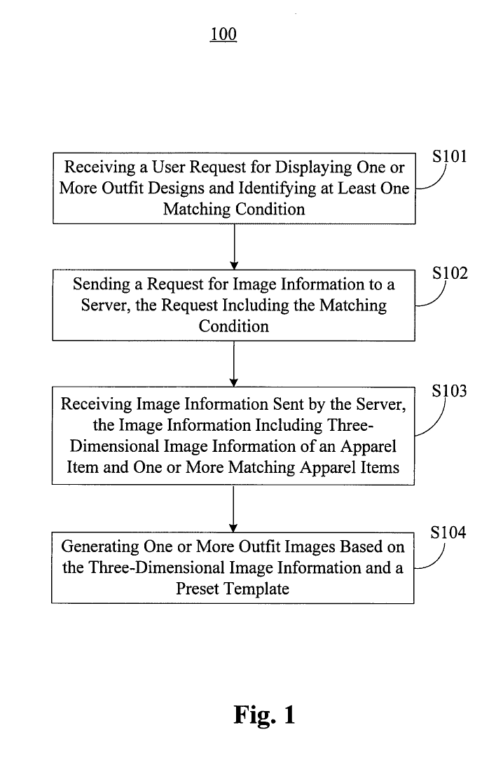

FIG. 1 is a flowchart of an exemplary image processing method 100, consistent with some embodiments of this disclosure. The exemplary method 100 may be performed by a client terminal. Referring to FIG. 1, the method 100 includes the following steps.

In step S101, the client terminal receives a user request for displaying one or more outfit designs and identifies at least one matching condition associated with the outfit designs.

The client terminal may provide one or more interfaces for the user to enter into the “dressing room” function. For example, an interface for entering the dressing room function may be included in a webpage providing detailed information of an apparel item. As another example, an interface for entering the dressing room function may be included in a home page of an online store. As another example, an interface for entering the dressing room function may be included in a home page of a fashion department, without requiring the user to first select a specific merchant or item. As another example, an interface for entering the dressing room function may be included in a webpage showing a favorites list of the user, since one reason that an item on the favorites list is not yet purchased by the user may be that the user has not found other apparel items that can be worn with the item as an outfit. As another example, an interface for entering the dressing room function may be included in a webpage showing list of previous orders of the user, since the user may need to purchase items matching the previously purchased item.

The client terminal may identify at least one matching condition associated with the outfit designs based on the interface from which the request is received. For example, if the user request is received in a home page of an online store, the client terminal may determine that the outfit designs are to be obtained from the store internally, and identify the matching condition as that each apparel item of the outfit designs belongs to the store. Correspondingly, a server may identify merchant information in each item of the outfit designs. If each item of an outfit design belongs to the same store as that the user request is received at, it may be determined that the outfit design meets the matching condition.

In some implementations, if the request is received in a home page of a fashion department, the client terminal may identify a feature tag of the desired outfit designs based on user properties, preferences, feature tags previously added by the user, and so on. The matching condition for the outfit designs may be that each of the outfit designs is associated with the feature tag. If an outfit design is associated with the feature tag, it may be determined that the outfit design meets the condition.

In some implementations, if the request is received in a detailed information page of an apparel item, the client terminal may identify the matching condition as that each apparel item in the outfit designs belongs to the same store as the apparel item.

In some implementations, if the request is received in a favorites list or an order list page of the user showing an apparel item, the client terminal may identify the matching condition as that the apparel item is included in each of the outfit designs.

In step S102, the client terminal sends a request for image information to a server, the request including the at least one matching condition. The server may identify outfit designs in the outfit database that satisfy the matching condition, where the outfit database includes one or more outfit designs, each including a set of apparel item matching one another.

After receiving the request sent by the client terminal, the server may obtain, from the outfit database, outfit designs that satisfy the matching condition and send the outfit designs to the client terminal. For example, the matching condition may be identified as item A is included in the outfit designs. Correspondingly, the server may identify items 1, 2, and 3 that satisfy the matching condition and send the information of items 1, 2, and 3 to the client terminal.

It is likely that users selecting the same apparel item may have different preferences in styles, brands, and so on. For example, some users may like simple style, while other users may like retro style and prefer certain brands. The purchasing power of different users may also be different, and the groups the users belong to affect their choice of outfit designs as well. Personalized information of the users may be considered in providing the outfit designs. For example, the matching degree between the apparel item and the matching items may be determined based on the user's personalized information, and the outfit designs may be filtered and/or re-ordered based on the matching degree.

In step S103, the client terminal receives image information sent by the server, where the image information includes three-dimensional image information of an apparel item and one or more matching apparel items.

In step S104, the client terminal generates one or more outfit images for display based on the three-dimensional image information and a preset template. For example, the preset template may include a preset mannequin.

In some embodiments, the server may store three-dimensional images of each apparel items, and the client terminal may be capable to perform the function of image processing by installing an application. For example, the server may send the three-dimensional images of the apparel items to the client terminal, and the client terminal may generate presentation pictures based on the three-dimensional images and the preset template.

For example, the merchant offering the apparel items may photograph these items to obtain the three-dimensional images, such that the client terminal may generate images simulating the effect of the apparel items on the preset template. The server may also restrict the format and size of the uploaded images and perform normalizing and/or enhancement processing on the images. The apparel items may also be photographed by professionals associated with the server, and samples may be sent to facilities associated with the server for photograph.

In some embodiments, the client terminal may use photographs and/or body measurement data of the user for setting the template. The client terminal may also provide images of templates for the user to select as the preset template to present the outfit image.

In some embodiments, the client terminal may provide a user interface to switch between multiple outfit images when the server sends multiple outfit designs to the client terminal. For example, the client terminal may display another outfit image upon receiving a switching request from the user. The client terminal may also provide a link for the user to turn to a webpage for purchasing the items in the outfit image.

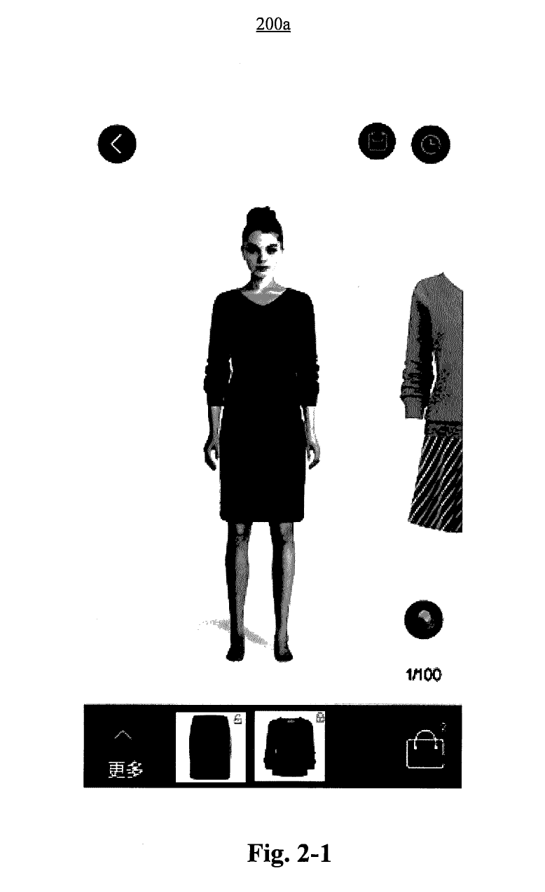

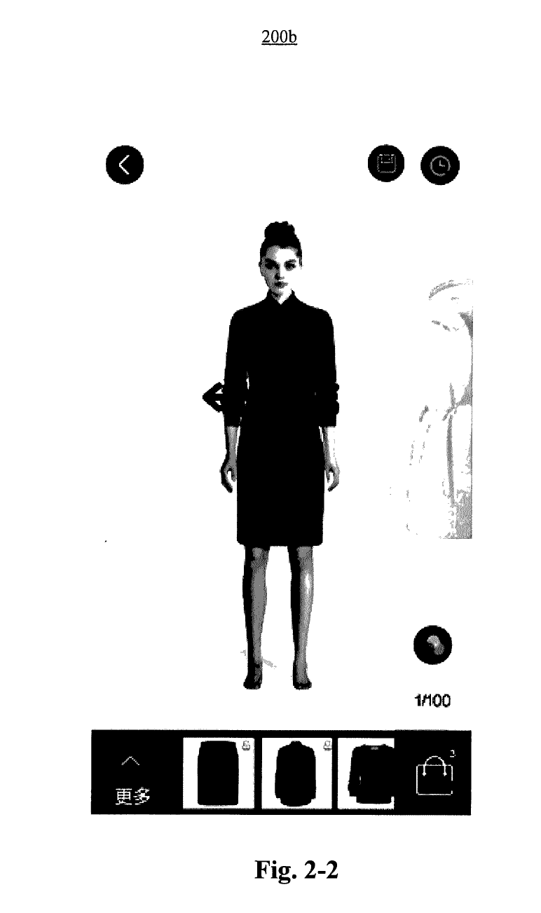

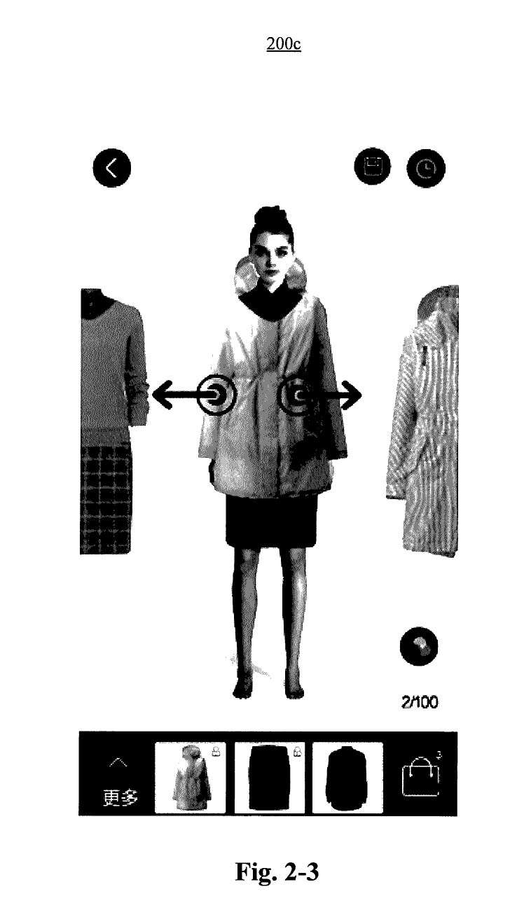

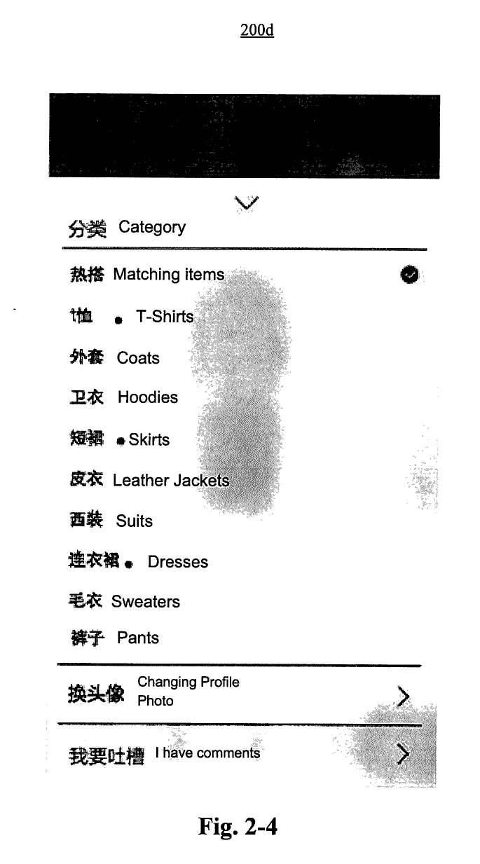

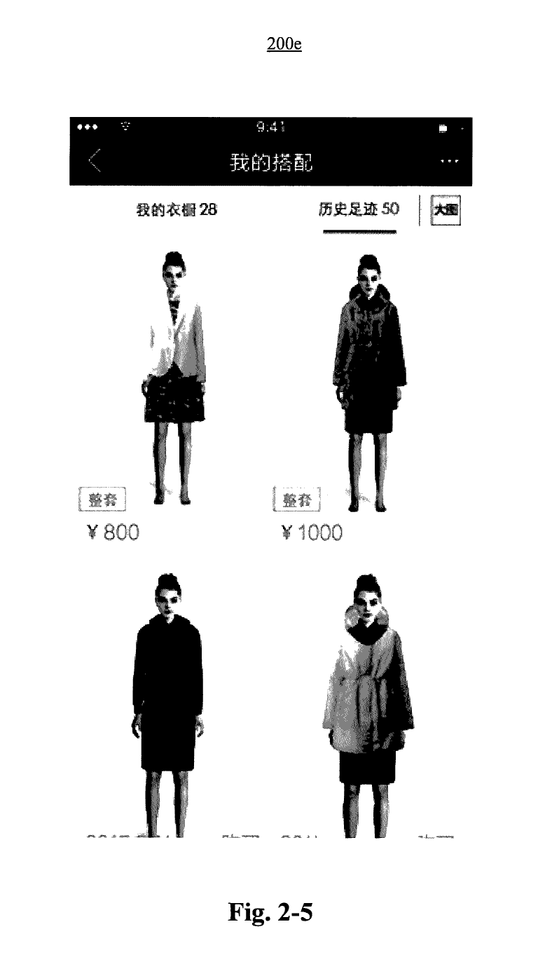

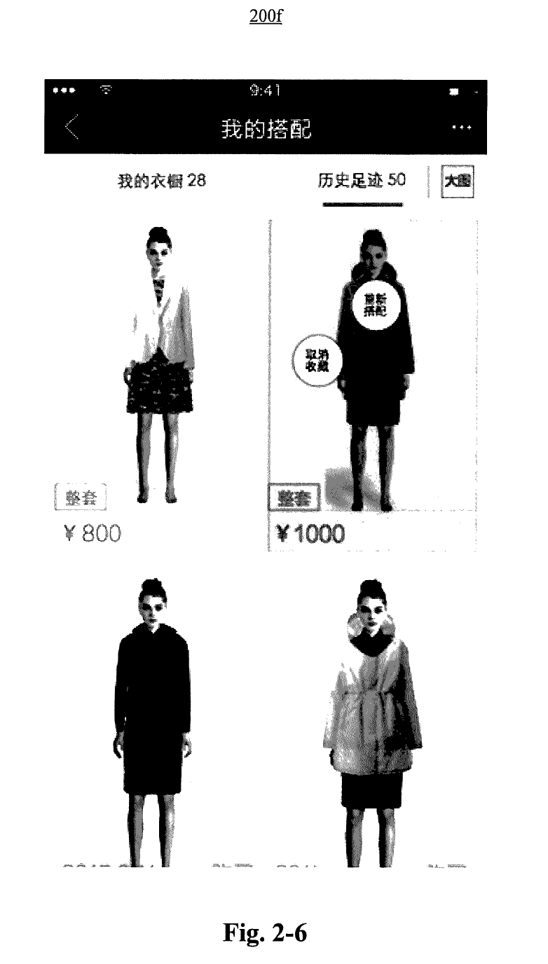

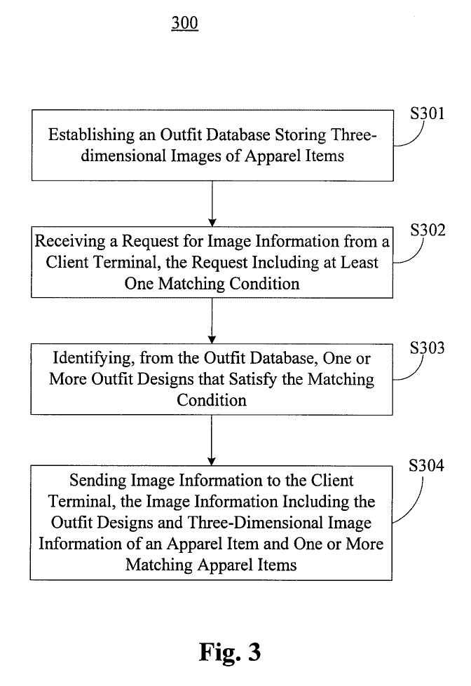

FIGS. 2-1 to 2-6 are schematic diagrams 200a-200e illustrating user interfaces for providing outfit images, consistent with some embodiments of this disclosure. For example, when the user enters the dressing room function via a homepage of an online store, the client terminal may display outfit images including outfit designs of the store. As shown in FIG. 2-1, the user interface displays an outfit image of a set of apparel items generated according to a template (e.g., apparel items worn on a mannequin) and provides an interface for switching to other outfit images. For example, the outfit images may be switched by the user performs a sliding operation on the images, and while the sliding operation is performed, the apparel items on the mannequin may be changed. When a user locks a displayed apparel item, the server may provide outfit designs for that item, and the client terminal may provide multiple outfit images for the item via a sliding interface. As shown in FIG. 2-2, the skirt on the mannequin is selected by the user, and the user may view outfit images with different matching items by performing sliding operations via the user interface. FIG. 2-3 shows the user interface when the user performs a sliding operation to the right side, and as a result, another outfit image is displayed. As shown in FIG. 2-3, the skirt locked by the user remains unchanged on the mannequin, and the matching apparel items have been changed. As shown in FIGS. 2-1 to 2-3, a link to each of the apparel items is provided in the user interface (e.g., at the bottom of the user interface) for the user to view detailed information of the items on the outfit image.

In some embodiments, the user interface may also display category information of the matching apparel items provided by the server. FIG. 2-4 shows a user interface displaying the category information of the apparel items.

In some embodiments, the user interface may provide an option for the user to add the displayed outfit images to the favorites list. The client terminal may add the selected outfit image to the favorites list upon receiving the user's request via the user interface. FIG. 2-5 shows a user interface displaying the favorite outfit images added by the user. The user interface may also provide an option for the user to delete an outfit image in the favorites list, for example, by the user pressing and hold an image. FIG. 2-6 shows a user interface for deleting a favorite outfit image by the user. As shown in FIG. 2-6, the highlighted image on the upper right position is being deleted by the user from the favorites list.

In some embodiments, the user interface may provide an option for the user to share an outfit image with other users. Upon receiving the request to share the outfit image, the client terminal may send information of the outfit image to other users, such as friends of the user, users randomly selected by the server, and so on. The server may monitor operations of the users that receive the shared outfit image, so as to obtain the statistical usage of the corresponding outfit design.

FIG. 3 is a flowchart of another exemplary image processing method 300, consistent with some embodiments of this disclosure. The exemplary method 300 may be performed by a server. Referring to FIG. 3, the method 300 includes the following steps.

In step S301, the server establishes an outfit database storing three-dimensional images of apparel items. The database includes at least one outfit design for each apparel item, where each outfit design includes an apparel item and one or more matching apparel items.

In step S302, the server receives a request for image information from a client terminal, where the request includes at least one matching condition for the image information.

In step S303, the server identifies, from the outfit database, one or more outfit designs that satisfy the matching condition.

In step S304, the server sends image information to the client terminal, where the image information includes the outfit designs and three-dimensional image information of an apparel item and one or more matching apparel items. The client terminal may generate outfit images for display based on the received image information and a preset template (e.g., a preset avatar or mannequin that could represent a user of the client terminal).

In some embodiments, an image processing server may perform the image processing to generate the outfit images. For example, the image processing server may be a dedicated server in the e-commerce platform or may be a third-party server. The image processing server may also perform normalization and enhancement techniques on the three-dimensional images of the apparel items. In some implementations, professionals associated with the image processing server may photograph the apparel items to obtain the three-dimensional images, for example, by obtaining apparel item samples from corresponding merchants.

In some embodiments, the image processing server may store a corresponding relation between an identifier of an apparel item and a three-dimensional image. For example, an e-commerce server receiving a request for image information may send identifiers of the apparel items in the outfit designs to the image processing server for generating the outfit images. The image processing server may then obtain three-dimensional images of the apparel items based on the identifiers, generate outfit images using a preset template, and send the outfit images to the e-commerce server, such that the e-commerce server may send the outfit images to the client terminal for displaying.

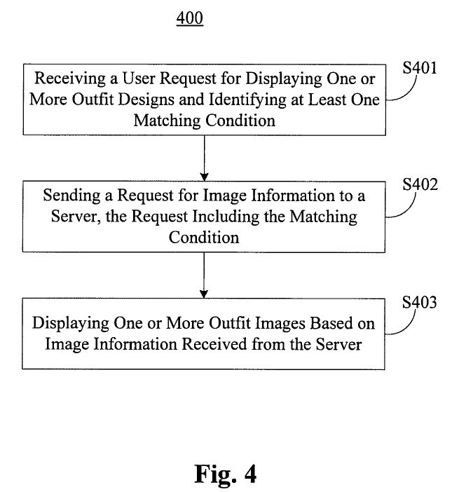

FIG. 4 is a flowchart of another exemplary image processing method 400, consistent with some embodiments of this disclosure. The exemplary method 400 may be performed by a client terminal. Referring to FIG. 4, the method 400 includes the following steps.

In step S401, the client terminal receives a user request for displaying one or more outfit designs and identifies at least one matching condition associated with the outfit designs.

In step S402, the client terminal sends a request for image information to a server, where the request includes the at least one matching condition. The server may identify outfit designs satisfying the matching conditions and send identifiers of corresponding apparel items to an image processing server. The image processing server may then obtain three-dimensional images of the apparel items in an image database based on the identifiers, generate outfit images based on the three-dimensional images and a preset template, and send the outfit images to the server. The image database may store one or more outfit designs, each of which includes an apparel item and at least one matching apparel item.

In step S403, the client terminal displays one or more outfit images to the user based on image information received from the server.

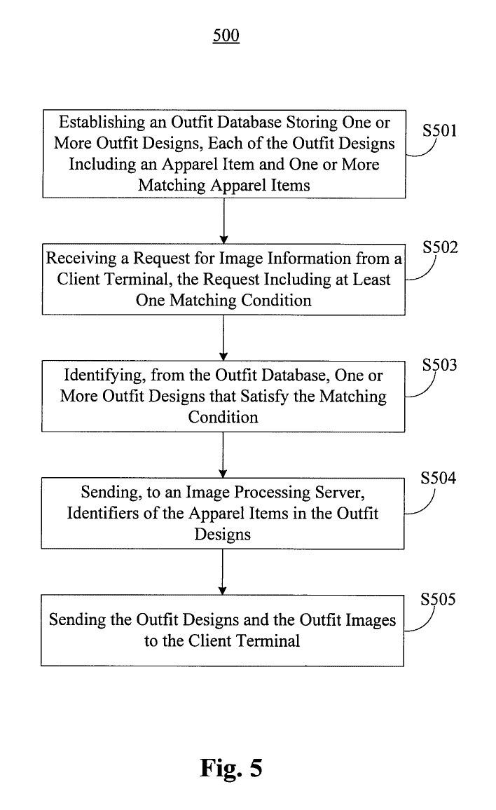

FIG. 5 is a flowchart of another exemplary image processing method 500, consistent with some embodiments of this disclosure. The exemplary method 500 may be performed by a server. Referring to FIG. 5, the method 500 includes the following steps.

In step S501, the server establishes an outfit database storing one or more outfit designs, where each of the outfit designs include an apparel item and one or more matching apparel items.

In step S502, the server receives a request for image information from a client terminal, where the request includes at least one matching condition for the image information.

In step S503, the server identifies, from the outfit database, one or more outfit designs that satisfy the matching condition.

In step S504, the server sends, to an image processing server, identifiers of apparel items in the outfit designs. The image processing server may subsequently obtain three-dimensional images of the apparel items in an image database based on the identifiers, generate outfit images based on the three-dimensional images and a preset template, and send the outfit images to the server. For example, the preset template may include a preset avatar or mannequin.

In step S505, the server sends the outfit designs and outfit images to the client terminal for display.

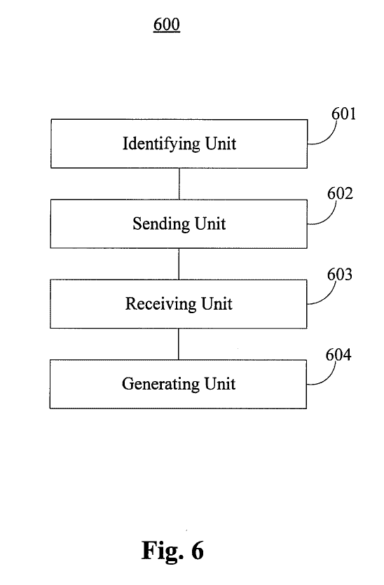

FIG. 6 is a block diagram of an exemplary image processing apparatus 600, consistent with some embodiments of this disclosure. The exemplary apparatus 600 may be implemented as a part or all of a client terminal. Referring to FIG. 6, the apparatus 600 includes an identifying unit 601, a sending unit 602, a receiving unit 603, and a generating unit 604.

The identifying unit 601 is configured to receive a user request for displaying one or more outfit designs and to identify at least one matching condition associated with the outfit designs.

The sending unit 602 is configured to send a request for image information to a server, where the request includes the matching condition associated with the outfit designs. The server may identify, in a preset outfit database, outfit designs that satisfy the matching condition, where the outfit database includes one or more outfit designs, each including an apparel item and one or more matching apparel items.

The receiving unit 603 is configured to receive image information sent by the server, where the image information includes three-dimensional image information of an apparel item and one or more matching apparel items.

The generating unit 604 is configured to generate one or more outfit images for display based on the three-dimensional image information and a preset template.

In some embodiments, the identifying unit 601 may include a first request receiving subunit and a first condition identifying subunit. The first request receiving subunit is configured to receive a user request via a homepage of an online store. The first condition identifying subunit is configured to identify the matching condition as that each apparel item of the outfit designs belongs to the store. Correspondingly, the server may identify merchant information in each item of the outfit designs. If each item of an outfit design belongs to the same store as that the request is received at, the server may determine that the outfit design meets the condition.

In some embodiments, the identifying unit 601 may include a second request receiving subunit and a second condition identifying subunit. The second request receiving subunit is configured to receive a user request via a home page of a fashion department and identify one or more feature tags of the outfit designs which describe a style, price range, occasion, and/or group associated with the outfit designs. For example, the second request receiving subunit may be configured to identify the feature tags based on user properties and/or user preferences in outfit designs. As another example, the second request receiving subunit may be configured to identify the feature tags based on a preset feature tag designated by the user. The second condition identifying subunit is configured to identify the matching condition as that each of the outfit designs is associated with the feature tags. Correspondingly, the server may determine that an outfit design meets the condition if the outfit design is associated with the feature tags.

In some embodiments, the identifying unit 601 may include a third request receiving subunit and a third condition identifying subunit. The third request receiving subunit is configured to receive a user request via a detailed information page of an apparel item. The third condition identifying subunit is configured to identify the matching condition as that each apparel item in the outfit designs belongs to the same store as the apparel item. Correspondingly, the server may identify outfit designs that include matching items from the same store as the apparel item.

In some embodiments, the identifying unit 601 may include a fourth request receiving subunit and a fourth condition identifying subunit. The fourth request receiving subunit is configured to receive a user request via a webpage of favorites list or order list of the user showing an apparel item. The fourth condition identifying subunit is configured to identify the matching condition as that the apparel item is included in each of the outfit designs. Correspondingly, the server may identify outfit designs that include the apparel item.

In some embodiments, the apparatus 600 may further include a locking unit and a determining unit. The locking unit is configured to provide a user interface to lock a displayed apparel item in the outfit images. The determining unit is configured to send, to the server, another request for image information corresponding to the displayed apparel item when the displayed apparel item is locked by a user input. Correspondingly, the server may identify outfit designs including the locked apparel item.

In some embodiments, the apparatus 600 may further include a template generating unit configured to generate a preset template based on a photograph and/or body measurement data of the user.

In some embodiments, the apparatus 600 may further include an image presenting unit and a template determining unit. The image presenting unit is configured to display one or more images of templates for the user to select as a preset template. The template determining unit is configured to determine the preset template based on the user's selection.

In some embodiments, the apparatus 600 may further include an input receiving unit and an image switching unit. The input receiving unit is configured to receive a user input to switch between outfit images when multiple outfit designs are received from the server. The image switching unit is configured to present another outfit image based on the received user input.

In some embodiments, the apparatus 600 may further include a link providing unit configured to provide a link to turn to a webpage for purchasing a matching apparel item shown in the outfit image. The user may turn to the webpage for purchasing the apparel item by selecting the provided link.

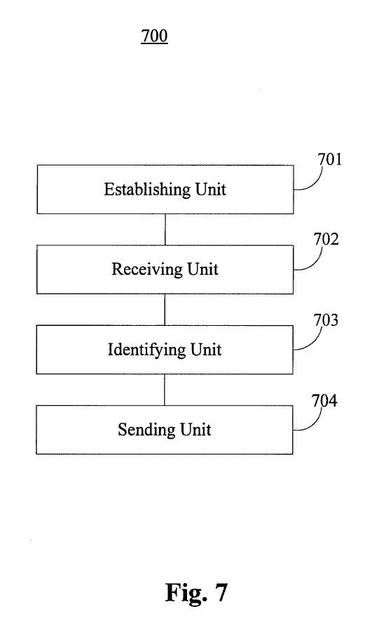

FIG. 7 is a block diagram of an exemplary image processing apparatus 700, consistent with some embodiments of this disclosure. The exemplary apparatus 700 may be implemented as a part or all of a server. Referring to FIG. 7, the apparatus 700 includes an establishing unit 701, a receiving unit 702, an identifying unit 703, and a sending unit 704.

The establishing unit 701 is configured to establish an outfit database storing three-dimensional images of apparel items. The outfit database includes at least one outfit design for each apparel item, where each outfit design includes the apparel item and one or more matching apparel items.

The receiving unit 702 is configured to receive a request for image information from a client terminal, the request including at least one matching condition for the requested image information.

The identifying unit 703 is configured to identify, from the outfit database, one or more outfit designs that satisfy the matching condition.

The sending unit 704 is configured to send image information to the client terminal, where the image information includes the one or more outfit designs and three-dimensional image information of an apparel item and one or more matching apparel items. The client terminal may generate outfit images for display based on the received image information and a preset template.

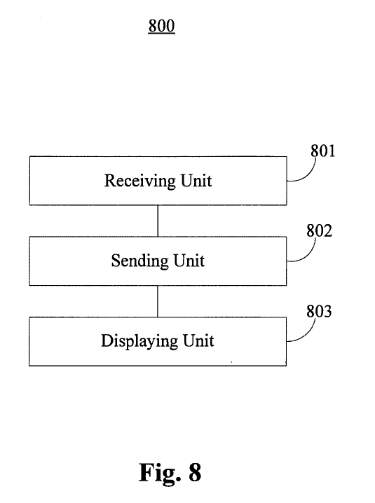

FIG. 8 is a block diagram of an exemplary image processing apparatus 800, consistent with some embodiments of this disclosure. The exemplary apparatus 800 may be implemented as a part or all of a client terminal. Referring to FIG. 8, the apparatus 800 includes a receiving unit 801, a sending unit 802, and a displaying unit 803.

The receiving unit 801 is configured to receive a user request for displaying one or more outfit designs and identify at least one matching condition associated with the outfit designs.

The sending unit 802 is configured to send a request for image information to a server, where the request includes the matching condition. The server may identify outfit designs satisfying the matching condition and send identifiers of corresponding apparel items to an image processing server. The image processing server may then obtain three-dimensional images of the apparel items in an image database based on the identifiers, generate outfit images based on the three-dimensional images and a preset template, and send the outfit images to the server. The image database may store one or more outfit designs, each of which includes an apparel item and one or more matching apparel items.

The displaying unit 803 is configured to display the outfit images to the user, where each the outfit images includes an apparel item and one or more matching apparel items worn on a preset template.

FIG. 9 is a block diagram of an exemplary image processing apparatus 900, consistent with some embodiments of this disclosure. The exemplary apparatus 900 may be implemented as a part or all of a server. Referring to FIG. 9, the apparatus 900 includes an establishing unit 901, a receiving unit 902, an identifying unit 903, a sending unit 904, and a providing unit 905.

The establishing unit 901 is configured to establish an outfit database storing one or more outfit designs, where each of the outfit designs includes an apparel item and at least one matching apparel item.

The receiving unit 902 is configured to receive a request for image information from a client terminal, where the request includes at least one matching condition for the image information.

The identifying unit 903 is configured to identify, from the outfit database, one or more outfit designs that satisfy the matching condition.

The sending unit 904 is configured to send, to an image processing server, identifiers of apparel items in the outfit designs. The image processing server may subsequently obtain three-dimensional images of the apparel items in an image database based on the identifiers, generate outfit images based on the three-dimensional images and a preset template, and send the outfit images to the server.

The providing unit 905 is configured to send image information to the client terminal for display, where the image information includes the outfit designs and outfit images.

The above described embodiments provide outfit designs and displays outfit images to a user, allowing the user to perceive effects of various outfit designs. In doing so, the user may conveniently view information of matching apparel items without performing cumbersome operations. The traffic loading of the server may also be reduced by the resource saving of the simplified user operations.

In exemplary embodiments, a non-transitory computer-readable storage medium including instructions is also provided, and the instructions may be executed by a device (such as a terminal device, a server, a personal computer, or the like), for performing the above-described methods. For example, the non-transitory computer-readable storage medium may be a ROM, a RAM, a CD-ROM, a magnetic tape, a flash memory, a cache, a register, a floppy disc, an optical data storage device, and the like.

It should be understood by those skilled in the art that the above described units and modules can each be implemented through hardware, or software, or a combination of hardware and software for allowing a specialized device to perform the functions described above. If implemented by software, it may be stored in the above-described computer-readable medium. One of ordinary skill in the art will also understand that multiple ones of the above described units may be combined as one unit, and each of the above described units may be further divided into a plurality of subunits.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. An image processing method, comprising:
receiving, at a client terminal, a user request for displaying one or more outfit designs;
identifying at least one matching condition associated with the outfit designs;
sending a request for image information to a server, wherein the request includes the at least one matching condition;
receiving the image information from the server, wherein the image information includes three-dimensional image information of an apparel item and one or more matching apparel items; and
displaying one or more outfit images based on the three-dimensional image information and a preset template.

2. The method according to claim 1, wherein the user request is received via a homepage of an online store, and wherein the at least one matching condition includes that each apparel item of the outfit designs belongs to the online store.

3. The method according to claim 1, further comprising:
identifying one or more feature tags associated with the outfit designs, wherein the user request is received via a homepage of a fashion department, and the at least one matching condition includes that each of the outfit designs is associated with the feature tags.

4. The method according to claim 3, wherein the feature tags are identified based on properties of the user or design preferences by the user.

5. The method according to claim 3, wherein the feature tags are set by the user.

6. The method according to claim 3, further comprising:
providing a user interface to lock a displayed apparel item in the outfit images;
receiving an input to select the displayed apparel item via the user interface; and
sending, to the server, another request for image information corresponding to the displayed apparel item.

7. The method according to claim 1, wherein the user request is received via a detailed information page of the apparel item, and wherein the apparel item belongs to an online store, and the at least one matching condition includes that each apparel item in the outfit designs belongs to the online store.

8. The method according to claim 1, wherein the user request is received via an order list page or a favorites list page showing the apparel item, and wherein the at least one matching condition comprises that the apparel item is included in each of the outfit designs.

9. The method according to claim 1, further comprising:
generating an image of the preset template based on a photograph of a user or body measurement data of the user.

10. The method according to claim 1, further comprising:
displaying at least one image of a template;
receiving a user input on the at least one image of a template; and
determining the preset template based on the user input.

11. The method according to claim 1, further comprising:
providing a user interface to switch among the outfit images; and
displaying one of the outfit images based on a user input on the user interface.

12. The method according to claim 1, further comprising:
providing a link to turn to a purchase webpage of the matching apparel items; and
displaying the purchase webpage of the matching apparel items upon receiving a user selection of the link.

13. An image processing apparatus, comprising:
an identifying unit that receives a user request for displaying one or more outfit designs and identify at least one matching condition associated with the outfit designs;
a sending unit that sends a request for image information to a server, wherein the request includes the at least one matching condition;
a receiving unit that receives the image information from the server, wherein the image information includes three-dimensional image information of an apparel item and one or more matching apparel items; and
a generating unit that generates one or more outfit images based on the three-dimensional image information and a preset template.

14. The apparatus according to claim 13, wherein the identifying unit comprises:
a first request receiving subunit that receives the user request via a homepage of an online store; and
a first condition identifying subunit that identifies that the at least one matching condition includes that each apparel item of the outfit designs belongs to the online store.

15. The apparatus according to claim 13, wherein the identifying unit comprises:
a second request receiving subunit that receives the user request via a homepage of a fashion department and identifies one or more feature tags associated with the outfit designs; and
a second condition identifying subunit that identifies that the at least one matching condition includes that each of the outfit designs is associated with the feature tags.

16. The apparatus according to claim 15, wherein the second request receiving subunit is further configured to identify the feature tags based on properties of the user or design preferences by the user.

17. The apparatus according to claim 15, wherein the second request receiving subunit is further configured to set the feature tags based on a user input.

18. The apparatus according to claim 15, further comprising:
a locking unit that provides a user interface to lock a displayed apparel item in the outfit images; and
a determining unit that sends, to the server, another request for image information corresponding to the displayed apparel item in response to a user input on the user interface.

19. The apparatus according to claim 13, wherein the identifying unit comprises:
a third request receiving subunit that receives the user request via a detailed information page of the apparel item, wherein the apparel item belongs to an online store; and
a third condition identifying subunit that identifies that the at least one matching condition includes that each apparel item in the outfit designs belongs to the online store.

20. A non-transitory computer readable medium that stores a set of instructions that is executable by at least one processor of a client terminal to cause the client terminal to perform an image processing method, the method comprising:
receiving, at a client terminal, a user request for displaying one or more outfit designs;
identifying at least one matching condition associated with the outfit designs;
sending a request for image information to a server, wherein the request includes the at least one matching condition;
receiving the image information from the server, wherein the image information includes three-dimensional image information of an apparel item and one or more matching apparel items; and
displaying one or more outfit images based on the three-dimensional image information and a preset template.
